(19) United States
(12) Patent Application Publication
(10) Pub. No.: US 2010/0021277 A1
(43) Pub. Date: Jan. 28, 2010

(54) Construction dry mix supplier and methods of use thereof

(76) Inventors: Michael Fritz, Eden Prairie, MN (US); Brian Carney, Lakeville, MN (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 12/220,319

(22) Filed: Jul. 23, 2008

(51) Int. Cl. B60P 1/00; B65G 47/18; B65G 37/00

(52) U.S. Cl. 414/523; 414/505; 414/526; 198/550.01; 198/589

(57) ABSTRACT

A supplier for dispensing dry mix construction materials, with a size and features for convenient and efficient use at a construction site.

### TECHNICAL FIELD OF THE INVENTION

The technical field relates to the construction industry and devices for dispensing dry mix materials, for instance mortar or concrete.

### BACKGROUND OF THE INVENTION

Dry mix construction materials, e.g., dry mix mortar, dry mix concrete, or other preblended dry construction materials are commonly used in the construction industry.

### SUMMARY OF THE INVENTION

Disclosed herein is a supplier that has a size and configuration for efficient movement and use in dispensing of dry mix construction materials. The supplier is low to the ground and sized so that just one person can load it using a lift (e.g., skid steer, fork lift), so that it saves loading time. One embodiment holds about a cubic yard of material but is small enough to go into a freight elevator or be placed in a standard-height room, or on a pickup truck, so it can be placed in close proximity to a mason or mason teams, indoors or outdoors, that need to periodically dispense small or large batches of the dry mix material. Currently, a mason has to either work from a pallet of small bags of mortar and a sand pile or send bulk totes to a large bulk dry mix dispenser located elsewhere on the site.

Portable dry mix storage or loading devices have proven useful on construction sites that require mixing significant amounts of preblended dry products such as mortar or concrete. For instance, silos can be trucked to a site to provide a depot of mortar on an as-needed basis. The silos can be refilled as needed onsite from bulk bags (typically about 3000 lbs each). When needed, discharge ports in the silos can distribute dry product to tubs for mixing elsewhere on the site or discharge directly to a mixer. Gravity-fed systems are conventionally preferred, with the discharge port being located under the silo at the lowest point. Some silos rest on legs that provide adequate clearance for tubs or mixers to be placed directly under the port, while other ports discharge to a vertical auger that lifts the dry product so it can be dispensed into the mixer, mixer-pump or other receptacle. These devices have been described, for instance, in U.S. Pat. No. 4,956,821. Some of these silos can hold many thousands of pounds, while others intake only one or two 3000 pound bulk bags at a time, as in U.S. Pat. No. 4,953,752.

Other devices are directed to directly controlling flow from a single bulk bag into a mixer, as in U.S. Pat. No. 5,415,323, which provides for a bulk bag to be suspended from loops on its upper portion and controlled by an operator pulling draw strings on its bottom to regulate flow directly into a mixer. These bulk bags are standard in the U.S. construction industry, and artisans are accustomed to using the draw strings to empty the bags. The bulk bags are about 1 cubic yard in volume, and about 3000 lbs by weight.

If a silo is not used at a construction site, then bulk bags of preblended mixes are used as needed to make materials as needed immediately before use. Or the sand, cement, and other materials are dumped on the site and mixed as needed. In the case of work that is not close to the source of materials, the mortar or concrete must be mixed and moved to the specific site of the work, or small bags of materials moved to a convenient location for manual use in a mixer.

The invention, however, increases efficiency by providing a supplier device for a single worker using a lift (forklift or crane), or other device as suited, to empty a bulk bag into a dry mix supplier, which is either already at, or then can be moved to, the specific site most convenient for its mixing and use. The supplier also eliminates the need for shoveling or manual loading of a mixer. The supplier itself can be made to accommodate about up to about 2 bulk bags while being compact enough to be loaded in a freight elevator, or operate in low-clearance settings such as a standard-height room in a building. In fact, the supplier can be made with a height and overall dimensions so that a low-clearance lift such as a standard skid-steer or forklift, can move the device. Other versions of the invention can be made with somewhat larger dimensions to accommodate up to about 4 or 5 bulk bags. These versions may not fit in most standard freight elevators but can be made with dimensions for use with a low-clearance lift or use in a standard-height room.

### BRIEF DESCRIPTION OF THE FIGURES

FIG. 1 is a perspective view of a dry mix supplier with a foldable auger in an operational position;

FIG. 2 is a perspective view of the embodiment of FIG. 1 with the auger in a storage position;

FIG. 3 is a perspective view of the embodiment of FIG. 1 with a cut-away view of the interior and the top doors omitted;

FIG. 4 is a perspective view of a removable power pack for use with a supplier;

FIG. 5 is a perspective view of a knife mounted on a grating for use in a supplier;

FIG. 6 is a top view of an embodiment of a supplier with the knife and grating of FIG. 5;

FIG. 7 is a perspective view of the embodiment of FIG. 1;

FIG. 8 depicts a method of using an embodiment of a supplier;

FIG. 9 is a perspective view of a supplier with two inlets;

FIG. 10 is a perspective view of the supplier of FIG. 9;

FIG. 11 is an exploded perspective view of a wheel assembly for a supplier;

FIG. 12 is a perspective view of an auger cover for a supplier;

FIG. 13A is an elevated view of a side of a supplier;

FIG. 13B is a side view as indicated at arrow B of FIG. 13A;

FIG. 13C is a plan view of the supplier of FIGS. 13A and 13B; and

FIG. 14 is a schematic of an unloading process for the embodiment of FIG. 9.

### DETAILED DESCRIPTION OF PREFERRED EMBODIMENTS

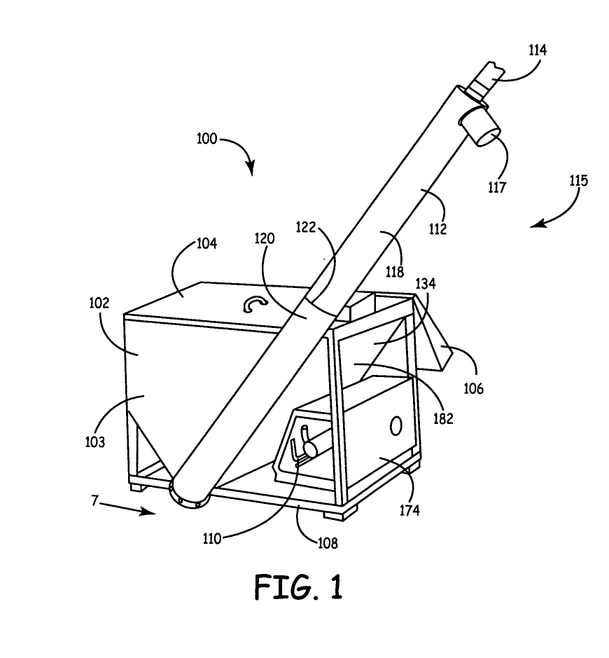

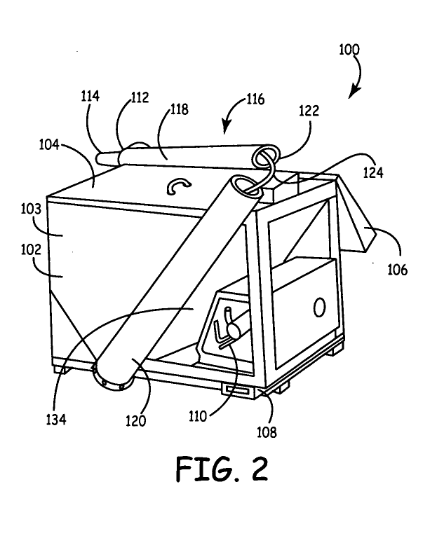

FIGS. 1-3 depict a supplier in perspective view. Supplier 100 has container 102, top doors 104, 106, frame 108, power supply 110 (shown partially), hydraulics 111, lifting auger 112, feeding auger 113, and lifting auger drive 114. FIG. 1 shows auger 112 in extended operating position 115, and FIG. 2 shows auger 112 in a folded storage position 116.

Auger 112 has upper portion 118 and lower portion 120 that cooperate at joint 122 to separate upper flight and bottom flight of auger 112, which interlock and are joined by interior cable 124. Lifting auger shaft 126 has vanes 128. Auger 112 may be placed at the side of the container, as shown, or disposed interiorly to the container, e.g., in the middle. Auger 112 has intake 125 and sliding sleeve 127 that allows for more or less of auger intake 125 to be exposed to the contents of the container to adjust the lift-out rate of the contents. Auger outlet 117 provides for the contents to exit the auger.

An auger is a rotating, single screw-type device that moves material through a cylinder or channel. The auger cylinder and the auger shaft are concentric, with the space between the shaft and the cylinder or channel defining an auger annulus. An auger in a channel is not necessarily concentric to the central axis of the channel, but may be so. The auger shaft is the rotatable rod that supports the auger vanes. Embodiments describe single augers but a plurality of cooperating augers may also be used. For instance, dual augers have a pair of screws in an auger cylinder or auger channel. An auger vane is a blade of an auger that provides motive force to move materials through the auger.

In general, augers used in the agricultural arts are not useful in moving preblended dry mix construction materials because the flighting design and clearance between the vanes and auger enclosure are different and not suited to moving preblended materials. For instance, augers for moving preblended materials require a larger clearance between the vanes and auger enclosure to allow for some potential aggregation of the preblend into hard lumps that can jam or damage the auger. Further, considerations of vane angle for control of slippage and de-mixing of the preblends require different augers.

Herein, some auger embodiments provide an option to run the auger in reverse upon demand to help clear the auger. Suppliers herein may include a hand-held controller with wireless communication or control wire that provides the user the opportunity to control the hydraulics and/or auger operation at any position around the supplier or remotely e.g., while operating a lift.

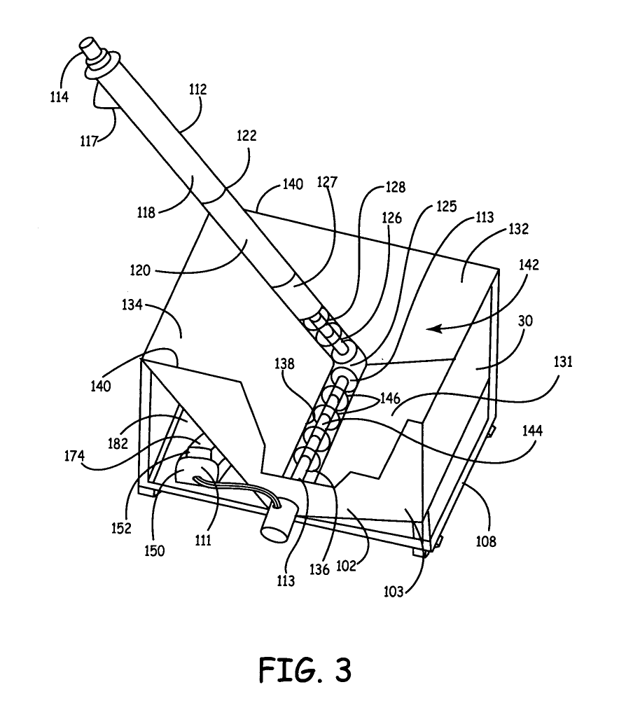

Container 102 has sidewalls 103, 130, 131, 132, 134, and floor 136 that is the bottom of channel 138. Container 102 has brim 140 that define opening 142. Brim 140 may further be equipped with doors 104, 106, or left open (FIG. 3). The term brim refers to the top edges. Doors or further structure may be added to a brim. Sidewalls 103, 132 are approximately parallel and vertical. Approximately parallel means diverging by an angle of no more than about 15 degrees. Sidewalls 130, 131 may alternatively be configured with sidewall 131 being substituted with a floor portion that is approximately parallel to a level surface that frame 108 rests upon with sidewall 130 correspondingly being extended to meet said floor portion. Channel 138, as depicted, may be a roughly V-shaped trough that defines the lowest portion of container 102. Alternatively, the channel may be rectangular, or otherwise shaped, or be eliminated and the sidewalls sloped to direct the contents of the container to a sump that feeds auger 112. Top doors 104, 106 may be hingedly joined to brim 140 and may be opened or closed as desired.

Frame 108 supports container 102 and provides a base for positioning the supplier in a level position on a flat surface or suitable supports that maintain the container in a level position. Supplier frames are provided with members as needed to stably support the container when fully loaded. The frames may have lift points for straps or cables (not shown) or slots for fork-lift arms.

Feeding auger 113 has shaft 144 with vanes 146. The channel may have a depth that is greater than the maximum diameter of the auger so that it rests entirely in the channel or the vanes may extend beyond the channel whereby the auger is partially disposed in the channel.

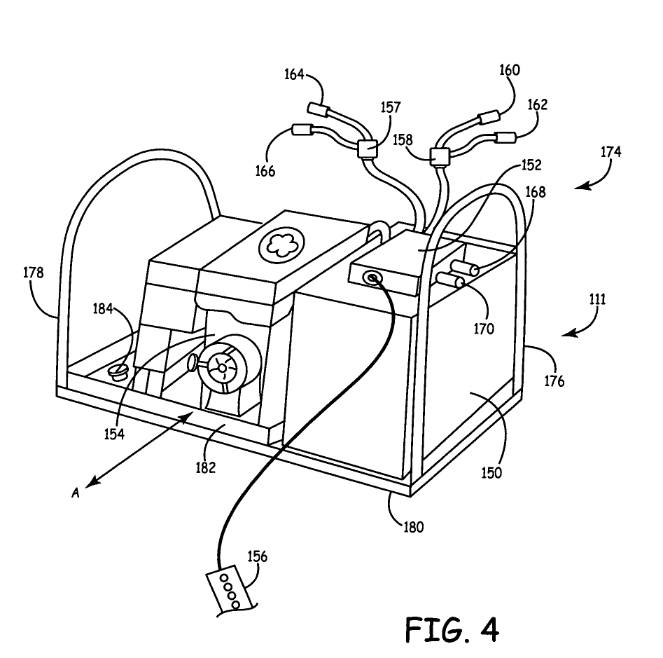

Hydraulics 111, see also FIG. 4, include hydraulic reservoir 150 and hydraulic manifold 152 and may be powered by a gasoline engine 154 or other motor, e.g., electric. Hydraulic hoses are generally not shown and making suitable plumbing for the same will be evident to artisans reading this disclosure. Controller 156 may be used to operate the hydraulics. Manifold 152 is depicted with two valve sets 157, 158 that each have a plurality of hydraulic hoses 160, 162, 164, 166 communicating with drivers for the augers to rotate the augers as required. The hoses may be equipped with quick-connects for ease of assembly and to facilitate changing out elements of the hydraulic or auger system. The hydraulic system may be equipped with quick connects 168, 170, or other suitable connections to allow the augers to be operated without power and/or hydraulics of the supplier; instead, external hydraulics may be used, e.g., as provided by a lifter's hydraulic system tied into the manifold via connectors 168, 170. A hydraulic power source may be chosen as appropriate and is a term that includes, e.g., a linear hydraulic motor (i.e., a hydraulic cylinder) or rotary hydraulic motor or hydraulic pump.

FIG. 4 further depicts a removable power pack 174 having sideframe members 176, 178 joined to bottom plate 180 so that a user may reversibly remove the power pack 174. Power pack 174 and/or plate 180 may be reversibly connected to frame 108. As depicted, e.g., FIG. 1, sidewall 134 slopes from brim 140 to frame 108 and defines space 182 between container 102 and frame 108 that receives power pack 174. Gasoline engine 154 may be substituted with an electric motor. The engine or motor may rest on a removable subpart, e.g., a drawer or tray, as in removable tray 182 that slides on and off of bottom plate 180 as indicated by arrow A in FIG. 4. Pin 184 secures the tray to the bottom plate and is removable to allow removal of the tray.

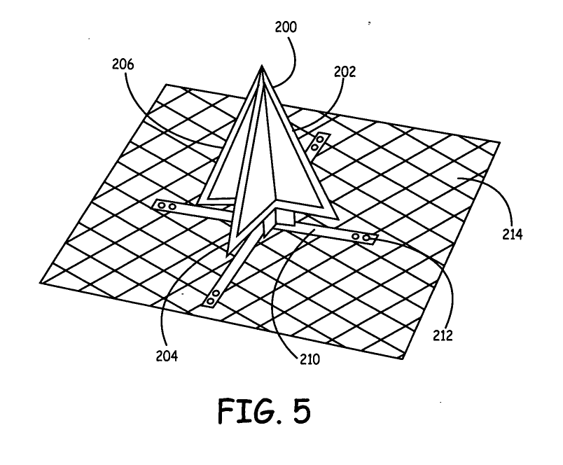

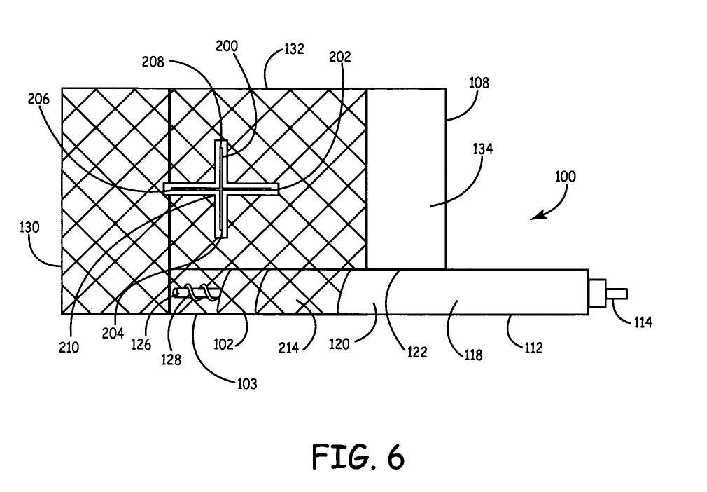

FIGS. 5-6 depict a four-bladed knife 200 with blades 202, 204, 206, 208 on four-armed stand 210 fastened with fasteners 212 to grate 214. The grate may be permanently or removably or hingedly mounted in container 102.

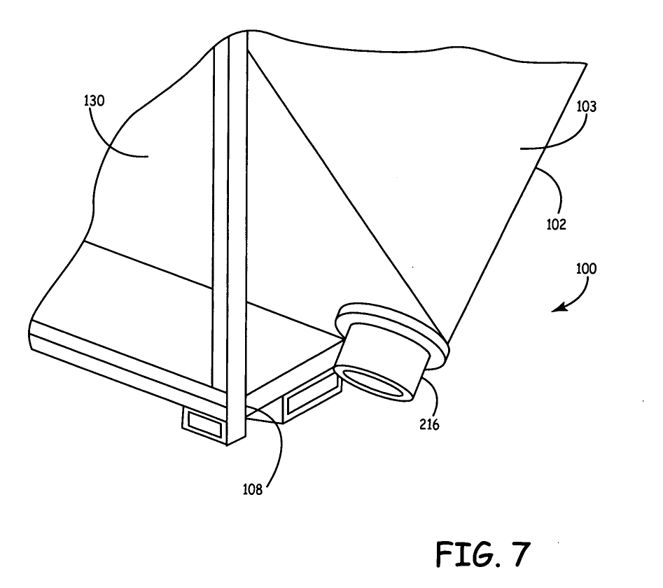

FIG. 7 depicts the mount 216 of auger 112. Frame 108 provides for supplier 100 to rest in a level position, either by placement on the ground or other level working-surface or on pallet material. The location of mount 216 on the bottom of the container provides for intake 125 to be located at or above the floor of container 102 and at or above all parts of container 102. The auger 112 is thus at or above the floor of container 102. This design significantly varies from alternatives that place the auger intake below the container, as in containers that provide for a gravity feed to the auger by placing it below the container. The floor of the container, with the term floor referring to the bottom-most portions of the container, is close the ground or other surface that the supplier rests upon. The term working-surface is used to refer to the ground the supplier rests upon, or other surface that it rests upon in the operational position, i.e., when loaded with dry mix and dispensing the same. The working-surface may be, for example, the floor of a building, a scaffolding floor, or pallet(s) that rest upon one of the same. The overall height of the device is operationally significant, and placing the floor of the container close to the working-surface is useful, e.g., within less than about 0.5, about 1, about 2, or about 3 feet artisans will immediately appreciate that all the ranges and values within the explicitly stated ranges are contemplated, e.g., less than 18 inches or between 2 inches and 24 inches.

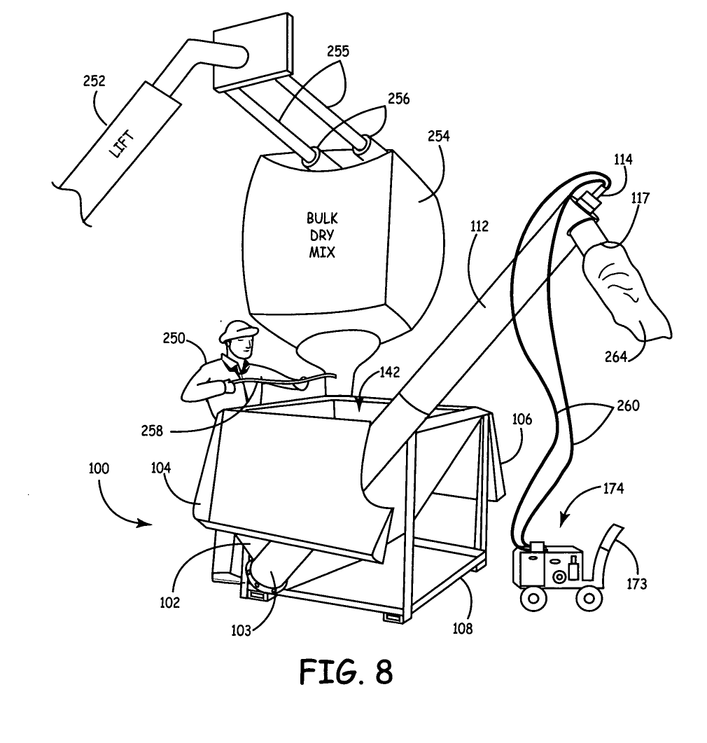

FIG. 8 depicts supplier 100 being loaded by a lift. User 250 uses a lift 252 to position bulk bag 254 attached to lift forks 255 via handles 256 over entry opening 142 and removes bulk bag drawstring 258 to release dry mix from the bag into the container. Alternatively, the supplier may be equipped with a knife as already described and the user can operate the lift to lower the bag onto the knife to be cut open and thereby release the contents. In this embodiment (FIG. 8), removable power pack 174 has been pulled from the supplier and placed on a hand-cart 173 to supply hydraulic power to auger 112 that operates auger drive 114 via hydraulic lines 260. This embodiment may alternatively be further provided with a feeding auger as already described, with the power pack further providing hydraulics to the same. Auger outlet 117 has sock 264 to provide direction to the dry mix as it exits the auger.

Once loaded with dry mix, lifting auger 112 may be turned to remove the dry mix and force it out of auger outlet 117 into a mixer or other location. Sliding sleeve 127 can be opened or closed to reveal more or less of the auger intake the thereby increase or decrease the flow rate of the dry mix out of the auger. The rotation rate of the auger may also be adjusted to control flow rate. Embodiments equipped with a feeding auger may operate the feeding auger intermittently as needed or continuously to direct dry mix to the lift-out auger.

Auger 112 may be folded at joint 122 for folding movement between a folded storage position and an extended operating position. The auger flights may be joined with fasteners, or a cable may run through the auger shaft as part of the joint. The tubing around the auger shaft may further be connected by a pivotable fastener that attaches to both upper portion 118 and lower portion 120. In use, a user folds and unfolds the auger as needed.

One embodiment of the supplier has a capacity of between about 0.8 to about 1.2 cubic yards and dimensions of less than about 60 inches width, less than about 60 inches depth, and less than about 60 inches height with the foldable auger in the folded position, wherein the inlet opening is more than about 1000 square inches in area. The container may be made with a floor of the container close to the working-surface, with or without a feeding auger to feed the lift-out auger, or with other features described herein. This embodiment has been made with a metal container and a metal frame with a total weight of less than about 1000 lbs.

In one embodiment, the dry mix supplier has a container that accommodates between about 2500 to about 3500 lbs of dry mix mortar or concrete material, or about 0.8 to about 1.2 cubic yards of the material and an auger for dispensing the material, with the supplier maximum dimensions in a storage position being no more than about 57 inches length×about 54 inches length×about 57 inches height. The auger is collapsed in the storage position. In use, the auger is extended to a maximum vertical height of more than 57 inches. A supplier with a capacity of about a cubic yard can be made with dimensions and weight to be transported in a standard-sized bed (about 4 feet wide by eight feet deep) of a half-ton pickup truck (1000 lb weight capacity); transportability using a commonly available vehicle is a considerable advantage.

In some embodiments, suppliers have an inlet or a plurality of inlets that accommodate bulk bag loading, with such an inlet being located a short distance from the ground (or other substantially level surface that the device rests upon in the loading and dispensing positions) so that the supplier can be easily loaded with a low-clearance lift that lowers a bulk bag downwards into the supplier. For instance, an inlet may be from about 3 feet to about 8 feet from the ground; artisans will immediately appreciate that all the ranges and values within the explicitly stated ranges are contemplated, e.g., about 45 inches, 4-5 feet, 4-8 feet, or less than about 6 feet. In some embodiments, the inlet, or pair of inlets, has a cross-sectional area approximately parallel to the ground of more than about 36 inches in diameter each, or an opening with a cross-sectional area of between about 1000 to about 2000 square inches each.

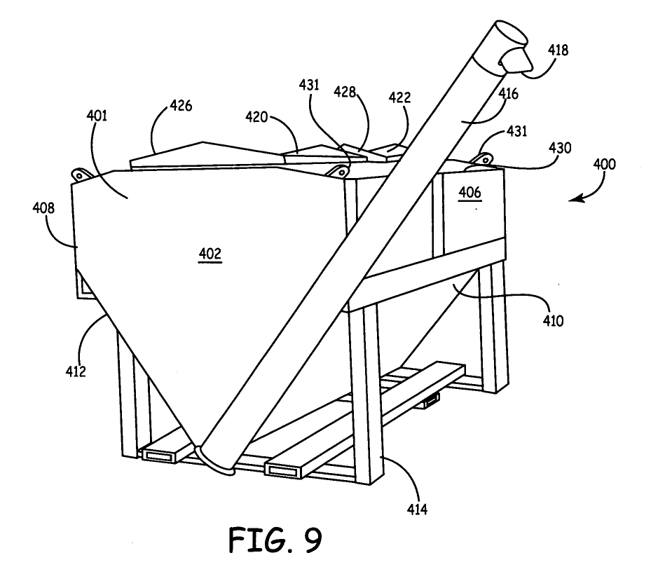

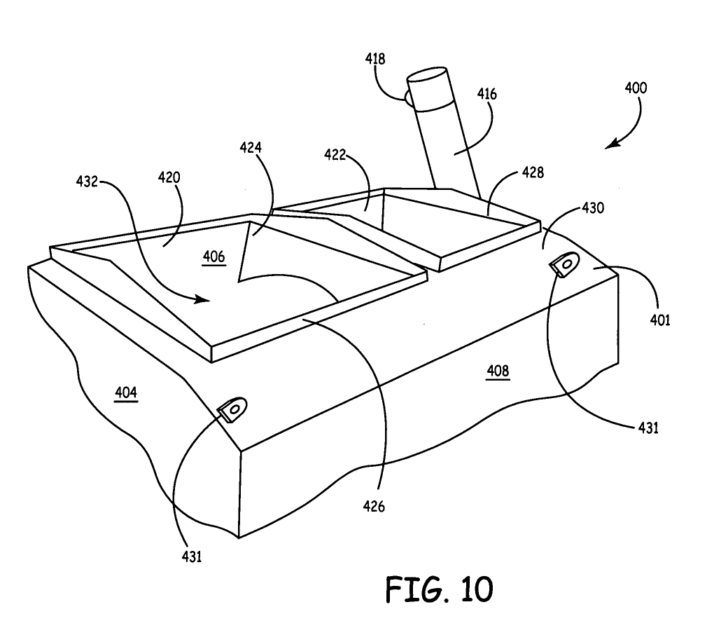

For instance, FIG. 9 depicts supplier 400 with container 401 having vertical parallel opposing sidewalls 402, 404, and opposing sidewalls 406, 408, that are partially sloped at 410, 412. Frame 414 supports container 401 and provides for support of the container on a level working-surface. Lift-out auger 416 has an intake (not shown) inside the container and outlet 418. The auger drive and hydraulics are not depicted. Alternatively, a foldable auger may be used. Other features described herein may be used with supplier 400, e.g., feeding auger, removable power pack, and alternative hydraulic connections. The bottom of the container and the openings in the container 420, 422 may also be positioned at heights and distances as already described, e.g., with the container close to the working-surface and the inlets at a certain height. Internal brace 424 may be added for extra stability. Lips 426, 428 may surround openings 420, 422 to provide a convenient guide for users directing bulk bags into one of the openings. Top panel 430 partially covers container interior 432 and has the openings 420, 422. Lift points 431 provide secure fixtures for lifting the supplier in an empty or full state; suppliers herein may generally be provided with lift points to provide for lifting the supplier with a full load of dry mix. Suppliers with two or more openings may be made with a capacity of between about 0.8 to about 6 cubic yards, e.g., from about 3 to about 6 or about 4 to about 5 cubic yards; artisans will immediately appreciate that all the ranges and values within the explicitly stated ranges are contemplated.

Suppliers may be made with an approximately rectangular footprint, meaning that the area covered by a projection of the top view is about square or about rectangular, with the auger being extra, or not included, when considering the projection. The opposing edges of the square or rectangle are within about 15 degrees of parallel. Rectangular refers to a rectangle or a square. The cuboidal aspect of a rectangle provides for efficient use of space. Suppliers with a footprint of less than about 4 feet by about eight feet may be seated in the bed of a full-size bed of a pickup truck or the like, and the weight of the supplier may be less than 1000 lbs in some embodiments to provide for transport in a half-ton pickup. Receptacles for lift-forks may be provided on the frame for loading and unloading by a forklift. Suppliers with a footprint of less than about 5 five by about five feet can be accommodated by common freight elevators, with a height of less than about five feet being helpful to provide for moving the supplier in or out of the elevator. Accordingly, embodiments include loading or unloading a supplier from a full-size bed or a freight elevator.

Grain carts and the like used in agricultural arts are generally directed to making the carts transportable or to cooperate with other farm equipment for efficient processing. Size, compactness, footprint, and movement by lift are not design parameters for such arts. In contrast, embodiments herein directed to compact size, clearance, or footprint or to stability in operation at a construction or other site solve problems specific to the construction arts that can not be addressed by prior approaches used in the agricultural or construction arts.

Suppliers may be made without an axle having wheels for pulling the supplier, as depicted in the Figures. Elimination of the axle keeps the container generally lower to the ground and without accommodations in the shape of the container; in other words, more designs are available for efficient use of space.

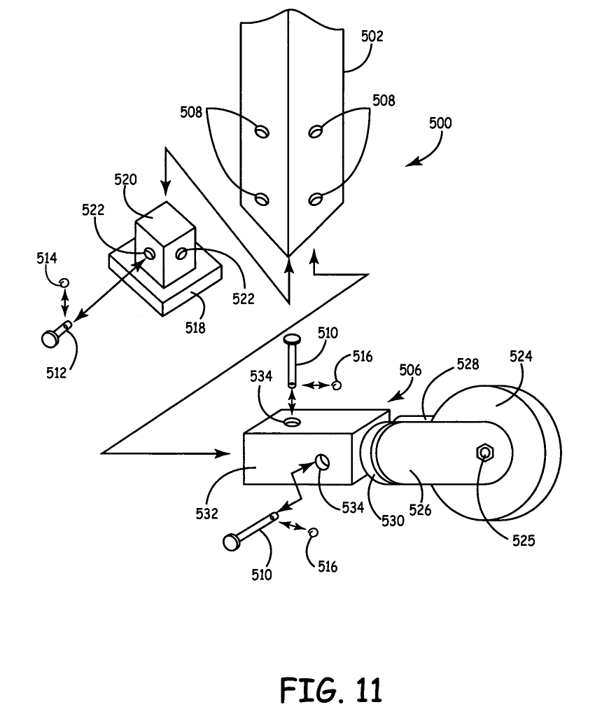

Suppliers may be provided with reversibly removable wheels, as in FIG. 11 which shows an exemplary embodiment 500 with a hollow supplier leg 502, foot assembly 504, and wheel assembly 506. Leg 504 has holes 508 to receive bolts 510, 512 that are in turn secured by pins 514, 516. Foot assembly has foot 518 on shaft 520 that fits into hollow leg 502. The foot assembly may be secured with bolt 512 that passes through holes 522 and 508, with pin 514 preventing unwanted removal. Wheel assembly 506 has wheel 524 mounted by axle 525 to shanks 526, 528, pivotable bearing assembly 530, and shaft 532 that has holes 534. Hollow leg 502 receives shaft 532, which may be secured with bolts 510 and pins 516. In use, the base assembly and wheel assembly may be interchanged as needed by inserting the desired assembly into the leg. The various supplier embodiments herein may readily be adapted to accommodate reversibly removable wheels.

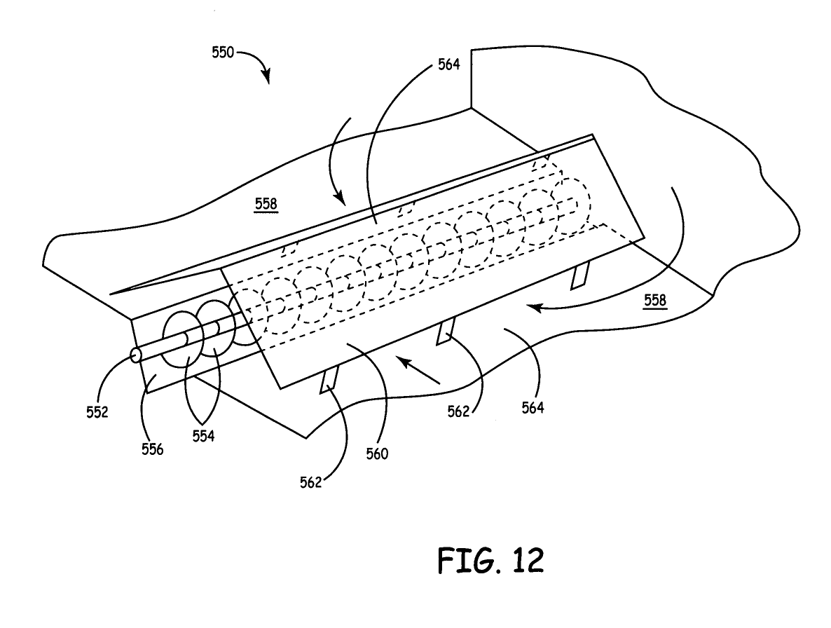

FIG. 12 depicts auger 550 with auger shaft 552, auger vanes 554, channel 556 disposed at the bottom of a container 558, and channel covering 560 supported by legs 562. The auger shaft is turned by a drive (not shown) and mounted (not shown) to the container 558. Openings 564 provide for flow of container contents from container 558 to auger 550. In use, the container is loaded with dry mix that flows through openings 564 to the auger, which moves the dry mix to a lift-out auger (not shown). The auger and/or channel covering 560 may be adapted to other embodiments described herein. The openings may have a height between the container floor and the lowermost edge of the covering of, for instance, between about 1 inch and about 24 inches; artisans will immediately appreciate that all the ranges and values within the explicitly stated ranges are contemplated, e.g., about 2 to about 24 inches, 3 inches, or 6 inches. The covering provides for a more complex flow of the container contents such that remixing is facilitated. Certain embodiments of the covering have two opposing sloped sides that meet at angle directed to the opening of the container, with the covering on one or more supports (e.g., legs, posts) that provide for an opening between the container and the edges of the covering. The angel between the sides may be, e.g., between about 45 degrees and 170 degrees; artisans will immediately appreciate that all the ranges and values within the explicitly stated ranges are contemplated, e.g., from about 90 to about 130 degrees. The edges of the covering may meet to define a ridge or be rounded to present an arcuate surface. For instance, a semi-cylindrical covering with its convex side facing the opening of the container may be used, with the cylinder being a semi-circle in cross-section or oblong. The covering may have a convex side and a concave side and be substantially disposed over the auger shaft (e.g., covering at least half or at least two-thirds of the shaft) with the concave side of the covering facing the auger shaft, e.g., as in FIG. 12, with concave in this context being a term that includes ridged or arcuate structures. The covering may be positioned to create one or more openings for material in the container to flow under the covering to the auger shaft and vanes.

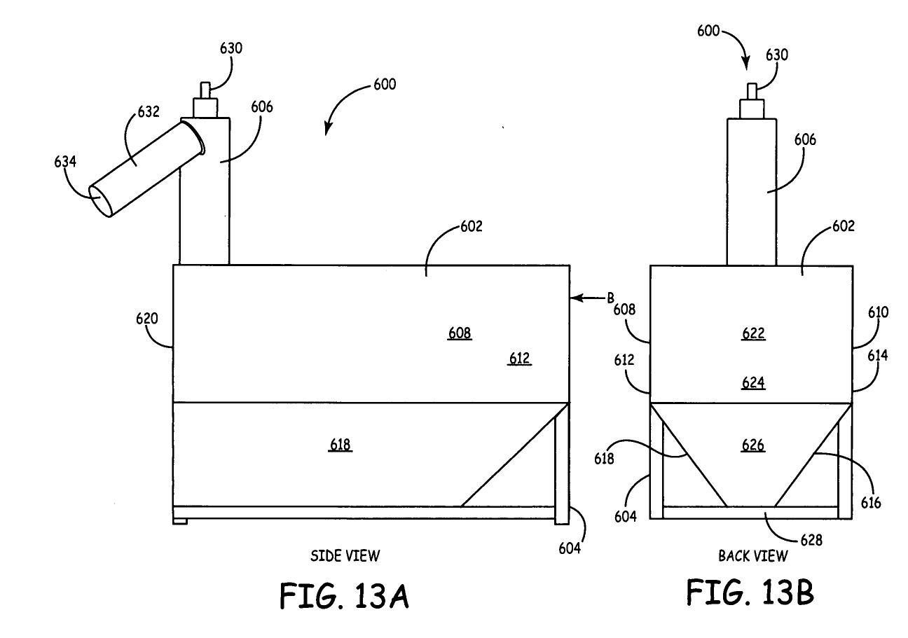

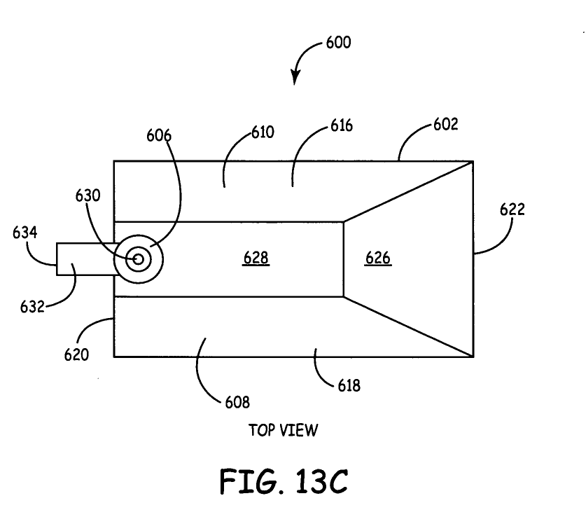

FIG. 13 depicts an alternative supplier 600 with a rectangular footprint. Container 602 is supported by frame 604 and has lift-out auger 606. Container 602 has opposing sides 608, 610, that each have opposing vertical members 612, 614 and opposing converging sloped members 616, 618. Container 602 also has opposing sides 620, 622, with side 620 being substantially vertical and side 622 having vertical portion 624 and sloped portion 626 that converges to join to container floor 628. Auger 606 has drive 630, outlet channel 632 and outlet 634. Hydraulics, power packs, wheels, or feeder augers may also be included in this embodiment, as well as other features described herein.

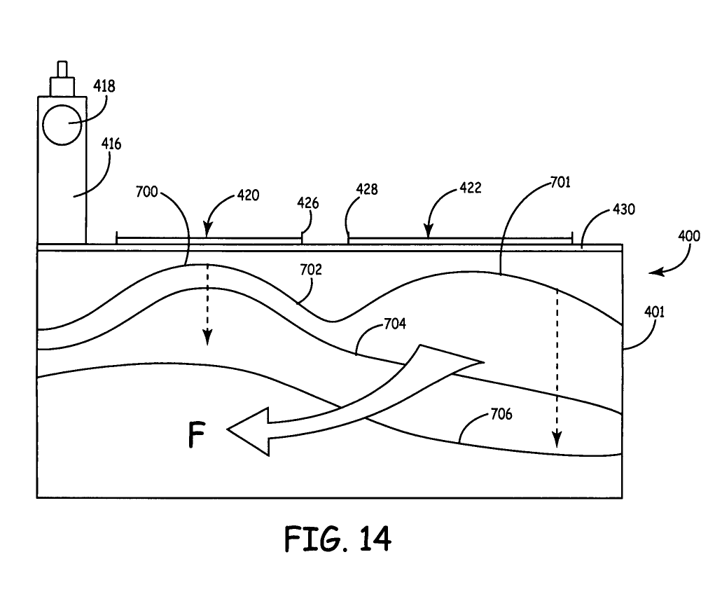

FIG. 14 schematically depicts an unloading sequence that has been observed for supplier 400. Bulk bags unloaded through openings 420, 422 tend to form bulges 700, 701 with the level of the premix indicated by line 702. As a feeder auger at the bottom of the container (not shown) passes material to lift-out auger 416, material feeds through the container as indicated by arrow F, with contents of one of the bags being predominantly removed before the contents of the other bag being removed. Lines 702, 704, 706 depict the progression of the height of the container contents as it is emptied. This emptying process can be achieved by controlling auger flighting, sizing, and rotation rates and provides for favorable mixing conditions to remix or prevent separation of preblended components.

Accordingly, an embodiment of a supplier is a portable dry mix supplier disposable on a substantially level working-surface for receiving and dispensing dry mix construction materials comprising: a frame attached to a container that defines a base for supporting the supplier by contact with the substantially level surface, with the container comprising with an interior capacity between about 0.8 to about 5 cubic yards and comprising sidewalls joining a brim of the container to a floor of the container that is less than about 18 inches from the working-surface; with a plane defined by a brim of the sidewalls comprising an inlet opening for receiving the dry mix material, with the inlet being disposed at a height of between about 4 feet to about 8 feet from the level surface; a foldable auger movable between an operable position to lift the dry mix material out of the channel and a retracted folded position, with the auger being at or above the base.

Another embodiment of a supplier is a portable dry mix supplier disposable on a substantially level surface for receiving and dispensing dry mix construction materials comprising: a frame supporting a container that defines a base; with the container comprising with an interior capacity between about 0.8 to about 5 cubic yards and comprising sidewalls shaped to pass contents of the container to a channel that provides a floor of the container and also provides a portion of the base, with the sidewalls comprising a pair of first and second approximately parallel opposing sidewalls and a third sidewall that slopes inwardly to define a space between the sidewall and the frame; with a plane defined by a brim of the sidewalls comprising an inlet opening for receiving the dry mix material, with the inlet being disposed at a height of between about 3 feet to about 8 feet from the level surface; a foldable auger movable between an operable position to lift the dry mix material out of the channel and a retracted folding position; and a second auger disposed in the channel oriented to direct contents of the channel to the foldable auger for uptake and lifting out of the container.

Another embodiment of a supplier is a portable dry mix supplier disposable on a substantially level surface for receiving and dispensing dry mix construction materials comprising: a container with an interior capacity between about 0.8 to about 5 cubic yards and comprising sidewalls joining a brim of the container to a floor of the container; with a plane defined by a brim of the sidewalls comprising an inlet opening for receiving the dry mix material, with the inlet being disposed at a height of between about 4 feet to about 8 feet from the level surface; a foldable auger movable between an operable position to lift the dry mix material out of the channel and a retracted folded position, with an inlet for the auger being at or above the base.

Another embodiment is a method of a method of loading a supplier resting on a substantially level surface with bulk bags of dry mix construction materials that are about one cubic yard in volume and dispensing the dry mix construction materials from the supplier, the method comprising: positioning a bulk bag of the dry mix construction material in or over an inlet opening of a supplier container and releasing the dry mix material into the container, and removing the bag from the container, wherein the inlet is between about 4 feet and about 8 feet from the surface, with the container comprising with an interior capacity between about 0.8 to about 5 cubic yards and comprising sidewalls joining a brim of the container to a floor of the container; and turning an auger to lift the dry mix material out of the container, with the auger being a foldable auger movable between an operable position to lift the dry mix material out of the container and a retracted folded position, with the auger being at or above the base.

Further embodiments relate to a supplier wherein the sidewalls are shaped to pass contents of the container to a channel that provides the floor of the container, with the sidewalls comprising a pair of first and second approximately parallel opposing sidewalls, and with a second auger disposed in the channel oriented to direct contents of the channel to the foldable auger for uptake and lifting out of the container. Another embodiment is a supplier wherein one of the sidewalls slopes inwardly to define a space between the sidewall and the frame, and further comprising a removable power pack that reversibly attaches to the frame in the space, the power pack comprising a hydraulic power source connectable to the supplier for operation of the auger. Another embodiment is a supplier wherein the power pack comprises connections for an external hydraulic power source for operation of the auger while the hydraulic power pack is bypassed. Another embodiment is a supplier wherein the hydraulic power source comprises a motor that is reversibly attached to the supplier with a manually operable fastener. Another embodiment is a supplier having a capacity of between about 0.8 to about 1.2 cubic yards and dimensions of less than about 60 inches width, less than about 60 inches depth, and less than about 60 inches height with the foldable auger in the folded position, wherein the inlet opening is more than about 1000 square inches in area. Another embodiment is a supplier having dimensions to pass through a doorway having a 60 inch width. Another embodiment is a supplier having an empty weight of less than about 1000 pounds. Another embodiment is a supplier comprising a knife in the container comprising a plurality of blades having edges facing the inlet opening. Another embodiment is a supplier wherein the auger, in the operable position, comprises an outlet for the auger contents that is at least about eight feet above the surface. Another embodiment is a supplier comprising a covering attached to the brim to cover the inlet opening. Another embodiment is a supplier wherein the supplier container and frame have an approximately rectangular footprint. Another embodiment further comprising dry mix construction material in the supplier or being added to the supplier, ore removed therefrom. Another embodiment is a supplier comprising wheels for rolling the container. Another embodiment comprises, before lifting the dry mix material out of the container, placing the supplier in a freight elevator having an entrance width of at least about 5 feet and a depth of at least about 7 feet. Another embodiment comprises, before placing the dry mix in the container, placing the supplier in a 4 foot wide by eight foot deep bed of a half-ton weight capacity pickup truck, with the total weight of the supplier being no more than about 1000 lbs.

Patent applications listed herein are each hereby incorporated by reference to the extent they do not contradict what is explicitly disclosed herein. Embodiments have been set forth with various features; these features may be freely mixed-and-matched among embodiments to make further embodiments as guided by the need to make a functioning device or method.

It is claimed:

1. A portable dry mix supplier disposable on a substantially level working-surface for receiving and dispensing dry mix construction materials comprising:
a frame attached to a container that defines a base for supporting the supplier by contact with the substantially level surface,
with the container comprising with an interior capacity between about 0.8 to about 5 cubic yards and comprising sidewalls joining a brim of the container to a floor of the container that is less than about 18 inches from the working-surface;
with a plane defined by a brim of the sidewalls comprising an inlet opening for receiving the dry mix material, with the inlet being disposed at a height of between about 4 feet to about 8 feet from the level surface;
a foldable auger movable between an operable position to lift the dry mix material out of the channel and a retracted folded position, with the auger being at or above the base.

2. The supplier of claim 1 wherein the sidewalls are shaped to pass contents of the container to a channel that provides the floor of the container, with the sidewalls comprising a pair of first and second approximately parallel opposing sidewalls, and with a second auger disposed in the channel oriented to direct contents of the channel to the foldable auger for uptake and lifting out of the container.

3. The supplier of claim 1 wherein one of the sidewalls slopes inwardly to define a space between the sidewall and the frame, and further comprising a removable power pack that reversibly attaches to the frame in the space, the power pack comprising a hydraulic power source connectable to the supplier for operation of the auger.

4. The supplier of claim 3 wherein the power pack comprises connections for an external hydraulic power source for operation of the auger while the hydraulic power pack is bypassed.

5. The supplier of claim 3 wherein the hydraulic power source comprises a motor that is reversibly attached to the supplier with a manually operable fastener.

6. The supplier of claim 1 having a capacity of between about 0.8 to about 1.2 cubic yards and dimensions of less than about 60 inches width, less than about 60 inches depth, and less than about 60 inches height with the foldable auger in the folded position, wherein the inlet opening is more than about 1000 square inches in area.

7. The supplier of claim 1 having dimensions to pass through a doorway having a 60 inch width.

8. The supplier of claim 7 having an empty weight of less than about 1000 pounds.

9. The supplier of claim 1 further comprising a knife in the container comprising a plurality of blades having edges facing the inlet opening.

10. The supplier of claim 1 wherein the auger, in the operable position, comprises an outlet for the auger contents that is at least about eight feet above the surface.

11. The supplier of claim 1 further comprising a covering attached to the brim to cover the inlet opening.

12. The supplier of claim 1 wherein the supplier container and frame have an approximately rectangular footprint.

13. The supplier of claim 1 further comprising dry mix construction material.

14. The supplier of claim 1 further comprising wheels for rolling the container.

15. A method of loading a supplier resting on a substantially level surface with bulk bags of dry mix construction materials that are about one cubic yard in volume and dispensing the dry mix construction materials from the supplier, the method comprising:
positioning a bulk bag of the dry mix construction material in or over an inlet opening of a supplier container and releasing the dry mix material into the container, and removing the bag from the container, wherein the inlet is between about 3 feet and about 8 feet from the surface, with the container comprising with an interior capacity between about 0.8 to about 5 cubic yards and comprising sidewalls joining a brim of the container to a floor of the container; and
turning an auger to lift the dry mix material out of the container, with the auger being a foldable auger movable between an operable position to lift the dry mix material out of the container and a retracted folded position, with the auger being at or above the base.

16. The method of claim 15 wherein the container further comprises a knife for cutting the bulk bag, and further comprising lowering the bulk bag onto the knife that cuts the bag and releases the dry mix material into the container.

17. The method of claim 15 wherein the sidewalls are shaped to pass contents of the container to a channel that provides the floor of the container, with the sidewalls comprising a pair of first and second approximately parallel opposing sidewalls, and with a second auger disposed in the channel oriented to direct contents of the channel to the foldable auger for uptake and lifting out of the container.

18. The method of claim 15 wherein the container has a capacity of between about 0.8 to about 1.2 cubic yards and dimensions of less than about 60 inches width, less than about 60 inches depth, and less than about 60 inches height with the foldable auger in the folded position, wherein the inlet opening is more than about 1000 square inches in area.

19. The method of claim 15 wherein the supplier has dimensions to pass through a doorway having a 60 inch width and an empty weight of less than about 1000 pounds.

20. The method of claim 15 wherein the container further comprises a covering attached to the brim to cover the inlet opening.

21. The method of claim 15 further comprising, before lifting the dry mix material out of the container, placing the supplier in a freight elevator having an entrance width of at least about 5 feet and a depth of at least about 7 feet.

22. The method of claim 15 further comprising, before placing the dry mix in the container, placing the supplier in a 4 foot wide by eight foot deep bed of a half-ton weight capacity pickup truck, with the total weight of the supplier being no more than about 1000 lbs.

23. The method of claim 15 wherein one of the sidewalls slopes inwardly to define a space between the sidewall and the frame, and further comprising a removable power pack that reversibly attaches to the frame in the space, the power pack comprising a hydraulic power source connectable to the supplier for operation of the auger.

24. The method of claim 23 wherein the power pack comprises connections for an external hydraulic power source for operation of the auger while the hydraulic power pack is bypassed, and further comprising connecting the external hydraulic power source to the connections.

25. The method of claim 23 wherein the hydraulic power source comprises a motor that is reversibly attached to the supplier with a manually operable fastener.

26. The method of claim 15 wherein the supplier container is at least partially supported by a frame, and the container and frame have an approximately rectangular footprint.

27. The method of claim 15 wherein the container further comprises wheels.

28. A portable dry mix supplier disposable on a substantially level surface for receiving and dispensing dry mix construction materials comprising:
a frame supporting a container that defines a base;
with the container comprising with an interior capacity between about 0.8 to about 5 cubic yards and comprising sidewalls shaped to pass contents of the container to a channel that provides a floor of the container and also provides a portion of the base, with the sidewalls comprising a pair of first and second approximately parallel opposing sidewalls and a third sidewall that slopes inwardly to define a space between the sidewall and the frame;
with a plane defined by a brim of the sidewalls comprising an inlet opening for receiving the dry mix material, with the inlet being disposed at a height of between about 4 feet to about 8 feet from the level surface;
a foldable auger movable between an operable position to lift the dry mix material out of the channel and a retracted folding position; and
a second auger disposed in the channel oriented to direct contents of the channel to the foldable auger for uptake and lifting out of the container.

29. A portable dry mix supplier disposable on a substantially level surface for receiving and dispensing dry mix construction materials comprising:
a container with an interior capacity between about 0.8 to about 5 cubic yards and comprising sidewalls joining a brim of the container to a floor of the container;
with a plane defined by a brim of the sidewalls comprising an inlet opening for receiving the dry mix material, with the inlet being disposed at a height of between about 4 feet to about 8 feet from the level surface;
a foldable auger movable between an operable position to lift the dry mix material out of the channel and a retracted folded position, with an inlet for the auger being at or above the base.

30. The supplier of claim 29 wherein the supplier has an empty weight of no more than about 1000 lbs and has dimensions of less than about 60 inches width, less than about 60 inches depth, and less than about 60 inches height with the foldable auger in the folded position, and the inlet opening is more than about 1000 square inches in area.
